(19) United States
(12) Patent Application Publication
(10) Pub. No.: US 2013/0032635 A1
(43) Pub. Date: Feb. 7, 2013

(54) E-commerce platform for extending the use of proprietary transponders and/or transponder accounts

(71) Applicant: Eliyahu Grinvald, Englishtown, NJ (US)

(72) Inventor: Eliyahu Grinvald, Englishtown, NJ (US)

(21) Appl. No.: 13/507,644

(22) Filed: Jul. 16, 2012

Related U.S. Application Data
(60) Provisional application No. 61/515,299, filed on Aug. 4, 2011.
(60) Provisional application No. 61/534,881, filed on Sep. 14, 2011.

(51) Int. Cl. G07B 15/02

(52) U.S. Cl. 235/384

(57) ABSTRACT

Transponders and transponder accounts or cell phone devices with large customer bases are modified to extend their use, particularly those used to pay tolls (e.g., E-ZPass® with over 20 million Transponders and 12 million transponder accounts), by creating an e-commerce platform utilizing the large customer base and/or large number of proprietary transponders in circulation for use in combination with drive thru or without as: (i) payment sources for retail transactions, vending machines, gated community entry/exit, gas/car battery fill-up/replacement purchases; (ii) linking points for use with computer devices related to a user's transponder account (iii) verification method for order pickups/parking reservation/parking subscription/special pricing, ATM machines; (iv) access to customized menus, location specific preferences, offers, VIP services, up-sale options and benefits and (v) receiver for advertisements, coupons or other information; or (vi) verification and payment method for self service (vii) social network/Facebook® check-in/advertisement.

### CROSS-REFERENCE TO RELATED APPLICATIONS

Applicant claims priority of U.S. Provisional Applications 61/515,299 filed Aug. 4, 2011 and 61/534,881, filed Sep. 14, 2011.

### BACKGROUND AND FIELD OF THE INVENTION

The present invention generally relates to the use of transponders and transponder accounts with large customer base. In particular, the system and methods herein described relate to the extension of transponders and transponder accounts, particularly those used to pay tolls (e.g., E-ZPass® with over 20 million Transponders and 12 million transponder accounts), by creating an e-commerce platform utilizing the large customer base and/or large number of proprietary transponders in circulation for use in combination with drive thru or without as: (i) payment sources for retail transactions, vending machines, gated community entry/exit, gas/car battery fill-up/replacement purchases; (ii) linking points for use with computer devices related to a user's transponder account (iii) verification method for order pickups/parking reservation/parking subscription/special pricing, ATM machines; (iv) access to customized menus, location specific preferences, games, offers, VIP services, up-sale options and benefits and (v) receiver for advertisements, coupons or other information; or (vi) Verification and payment method for self service (vii) Social network/Facebook® check-in/advertisement. Alternatively, the systems and methods of the invention can be used with a cell-phone carrier's customer base by utilizing the cell phone device as the electronic identification signal generator.

### DESCRIPTION OF RELATED ART

Fruend, published application 2003/0187787, Oct. 2, 2003 shows a payment system using RFID devices such as E-ZPass® which allows transactions other then toll transactions to be made.

Tuton, et al, published application 2005/0197976, Sep. 8, 2005 describes a toll payment system for fleet transactions where a single fleet account indentifies separate vehicles as members of the fleet.

Batra, published application 2007/0285256, Dec. 13, 2007 discloses a RFID tag.

Thibedeau, published application 2007/0276727, Nov. 29, 2007, Byerly et al, published application 2009/0036103, Feb. 5, 2009, Michaels, published application 2009/0262928, Oct. 23, 2008, and Bryant, published application 2010/0280873, Nov. 4, 2010 automatically process manufacturers' coupons.

Rosenberg, published application 2008/0238610, Oct. 2, 2008, utilizes smartcard devices in a variety of applications.

Clayman, published application 2009/0038609, Mar. 5, 2009, and Chakris, et al., published application 2009/094583, read RFID tags on products at the point of purchase.

Griffin, et al., published applications 2009/0193500, Jul. 30, 2009, 2009/0191811, Jul. 30, 2009, 2009/01922912, Jul. 30, 2009, and 2009/0192937, Jul. 30, 2009, involve the activation and authorization of a near field communication device.

Castro Abrantes, et al., published application 2009/0202105, Aug. 13, 2009, discloses an automatic license place recognition system used in an electronic toll collection system.

Robinson, et al., published application 2010/0114675, May 6, 2010, is a vehicle toll collection and billing system for tracking rental vehicles.

McElwaine, et al., published application 2010/0277321, Nov. 4, 2010 is an interactive marketing system sensing the presence of an RFID device and displaying consumer information related to the product associated with the detected RFID device.

Deitiker, et al., published application 2011/0047009, Feb. 24, 2011 disclose a toll collection system where the customer can select among difference pre-registered payment options.

U.S. Pat. Nos. 6,574,603 and 7,201,315 disclose automated service station systems.

PAYPASS® is a known payment system linking a mobile device with a credit card.

The prior art discussed above neither expands the use of the existing E-ZPass® system nor disclose the drive thru functionality of this invention.

### BRIEF DESCRIPTION OF THE DRAWINGS

FIG. 1 is a schematic overview of certain implementation methods in accordance with an embodiment of the present invention;

FIG. 2 is a diagram of a certain exemplary payment choices in accordance with an embodiment of the present invention;

FIG. 3 is a high level system diagram in accordance with an embodiment of the present invention;

FIG. 4 is a high level system diagram in accordance with an embodiment of the present invention; and

FIG. 5 is a diagram of an installation of the present invention at a dry cleaning establishment.

### DETAILED SPECIFICATION

The present invention generally relates to the use of transponders. In particular, the system and methods herein described relate to the extension of transponders, particularly those used to pay tolls (e.g., E-ZPass Transponders), for use as: (i) payment sources for retail transactions, vending machines, gas purchases; (ii) verification method for order pickups, ATM machines; (iii) access to VIP services, customized menus, offers, up-sale options and benefits; (iv) Act as an identifier for showing and/or receiving targeted advertisements, coupons or other information through any selected medium (e.g., receipt, printed label/printout, screen/bulletin board, linked device, linked Facebook/Email/other account); and (v) Auto Facebook®/other social network check-in and/or customized advertisement/coupon based on Facebook/social network account information.

According to an embodiment of the present invention, the systems and methods herein described are accomplished through the use of one or more transponders and/or transponder accounts. Transponders, such as those utilized by E-ZPass, are commonly battery powered RFID transponders, using active RFID read/write technology (e.g., active Type II read/write technology) to listen for a signal broadcast from a signal reader, usually at a toll booth. One skilled in the art would appreciate that the system and methods herein described would work with numerous transponder types and transponder account types, and embodiments of the present invention are contemplated for use with any type of electronic devices which generate an identification signal and device account type.

According to an embodiment of the present invention, the systems and methods herein described are designed to extend the functionality of transponders beyond the simple payment of tolls. In this regard, the systems and methods described herein are designed to allow one or more transponders and transponder accounts to be transformed into a full-fledged payment, identification and transaction system, whereby a user can utilize his/her transponder and/or transponder account to partake in one or more non-toll transactions. These and other features and advantages of the present invention will be explained and will become obvious to one skilled in the art through the description that follows.

Oftentimes a successful proprietary system begs to be extended beyond its well defined cast-in-concrete boundaries to the significant economic and life style benefits of the region where it is operating. So is the case with transponders and transponder accounts used to pay tolls, as is the case with E-ZPass and E-ZPass accounts with its over 20 million transponders in circulation and 12 million transponder accounts.

Oftentimes the complexity of the proprietary transponder based toll-payment system and/or transaction cost structure and/or transaction speed of execution and/or length of fraud detection and/or length of payment settlement and/or inability to guarantee payment in the event of a non-paying customer and/or replacement/transition cost and/or active contracts and/or operation/organization complexity and/or security/privacy concerns and/or complexity of division/allocation of customer account funds and/or division/allocation of system/organization resources and/or organization deadlocks prevent significant regional economic and life style benefits from being utilized.

The current invention solves all these problems unlocking the great economic and life-style potential by creating an e-commerce platform loosely coupled at the organization, operation, resource and system levels with the existing transponder and transponder account organization, operation, resources and systems as follows:
1. E-ZPass and/or other toll paying services optionally allow non-toll services to be marketed to their customers;
2. E-ZPass and/or other toll paying service customers register with the platform linking their method of payment and/or method of identification and/or preferences and/or their proprietary transponder/transponder and/or account and/or the e-commerce platform transponder/method of payment;
   a. Optionally, in-addition and/or instead E-ZPass and/or other toll paying service customers register through authorizing use of their information by the e-commerce platform in which case E-ZPass and/or other toll paying services, under customer direction and authorization will provide the customer record to the e-commerce platform for example through an exchange of feed files;
3. E-ZPass Group and/or other toll paying services provide lost/stolen tags feed periodically (e.g., on an hourly basis);
4. E-ZPass Group and/or other toll paying service provide tag status feed periodically (e.g., daily) showing which customers' tags are no longer eligible to participate in their corresponding toll paying service;
5. E-ZPass Group and/or other toll paying services license the use of their Service Mark;
6. E-ZPass Group and/or other toll paying services grant permission to purchase readers;
7. The non-toll e-commerce platform provider installs/maintains the equipment in the non-toll business either directly or through a third party provider;
8. Non-toll Customer/business support/service is handled by the non-toll e-commerce platform provider either directly or through a third party provider; and
9. A provision will be made in the platform to exclude products not authorized by E-ZPass group or/and other toll paying services such as Alcoholic beverages, gambling.

The current invention benefits all stakeholders as follows:
1. E-ZPass/Other toll paying groups—Receive economic incentive/increased revenues with minimum amount to no additional investment, efforts and risk;
2. E-ZPass/other toll paying group customers save time, and enjoy personalization of service received/product bought (e.g., showing a personalized menu at a Quick Service Restaurant (QSR), linking a standing order to recognition of arrival, get their coffee exactly as they like it), and ability:
   a. Optionally, to use funds and/or preferences allocated to a transponder with other method of payment/(e.g., NFC, credit/debit/pre-paid card) and/or method of identification;
3. Businesses benefit from increased revenues as a result of faster service and higher level of repeat buying;
4. Other service providers utilizing the E-Commerce platform to offer additional services such as:
   a. Centralized gated community/condos/RV/Tractor Trailer parking access and/or restricted area access based on any of platform customer recognized method of identifications and method of payments, or
   b. Web based food ordering utilizing the platform method of payment and pickup arrival detection and linking to their order;
5. Advertisers/Coupons Submission Businesses
   a. Allowing neighboring businesses to use the e-commerce platform to submit their coupon to be printed/shown on a display/forwarded to customer linked device when a customer is detected at a POS based on customer preferences,
   b. Neighboring businesses can use the e-commerce platform to submit ad-hoc advertisement/coupon for perishable or excess product capacity as the customer is physically at a POS of a neighboring business and/or local to the region (e.g., the system can recognize an out-of-town customer purchase in the PM hours and offer an hotel stay promotion at a participating neighboring hotel that currently has available rooms), or
   c. Bulletin boards—customer preferences based advertisement and/or notifications.

### Account Linking

According to an embodiment of the present invention, to maintain the separation of monies & systems designated for toll payment, registration may be required for a transponder to part-take in this system. During registration, customers link any or all of the following: form of payment(s), preferences and general information to their transponder(s) if they have one or a new transponder and/or possibly a new form of payment (e.g., pre-paid card)

According to an embodiment of the present invention, users may be provided the ability to link transponders and/or other method of identifications with one or more methods of payments (e.g., credit card account, debit card account, direct debit (ACH) from a bank account). One of ordinary skill in the art would appreciate that there are numerous methods for linking an account to a method of payment, and embodiments of the present invention are contemplated for use with any method of linking an account to a method of payment. Additionally, the system may be configured to receive prepayments and allow for standing account debits to be used to pay for non-toll transactions.

According to an embodiment of the present invention, the system may be configured to allow a user the ability to link one or more computing devices to their transponder account (e.g., E-ZPass account), allowing the user to make payments for transactions with any computing device they have linked to their transponder account. One of ordinary skill in the art would appreciate that a computing device appropriate for use with embodiments of the present application may generally be comprised of one or more of a Central processing Unit (CPU), Random Access Memory (RAM), and a storage medium (e.g., hard disk drive, solid state drive, flash memory). Examples of computing devices usable with embodiments of the present invention include, but are not limited to, personal computers, smart phones, laptops, mobile computing devices, embedded computing devices and servers. One of ordinary skill in the art would understand that any number of computing devices could be used, and embodiments of the present invention are contemplated for use with any computing device.

According to an embodiment of the present invention, once a user's transponder account is linked to the desired devices (e.g., transponder, smart phone, tablet PC), the system may utilize one or more of the linked devices to participate in one or more transactions as detailed herein. Not every merchant or transaction type may be available to every linked device. The system may be configured to determine whether a particular linked device is appropriate for a particular transaction or transaction type. For instance, a transponder without a display component may not be appropriate for a transaction type requiring visual interaction (e.g., display coupons).

### Transaction Types

According to an embodiment of the present invention, the system is configured to allow the use of transponders, transponder accounts, computing devices or any combination thereof in one or more transaction types. Transaction types include, but are not limited to, use of a transponder as a payment instrument for retail transactions, use of a transponder as a payment instrument for gas purchases, use of a transponder as a payment instrument at a vending machine, use of a computer device linked to a transponder account as a payment instrument for retail transactions, use of a computer device linked to a transponder account as a payment instrument for gas purchases, use of a computer device linked to a transponder account as a payment instrument at a vending machine, use of a transponder for identification of a user and verifying order pickups, use of a transponder for ATM transactions; use of a transponder to access VIP and customized menus, upsale offers, services and benefits, use of a computing device to access VIP and customized menus, upsale offers, services and benefits, use of a transponder as a receiver for advertisements, coupons or other information and use of a computing device linked to a transponder account as a receiver for advertisements, coupons or other information. Use of a device linked to a transponder account for communication with a vendor, merchant, service provider, or kiosk for the purpose of completing a transaction.

According to an embodiment of the present invention, a transponder may be used as a payment source at any participating and appropriately configured vendor, merchant, service provider or a kiosk. The transponder may be configured to receive a signal from said appropriately configured vendor, merchant, service provider or kiosk. This signal will be provided by, for example, an appropriately configured computing device, capable of interacting with the transponder. The transponder, upon receiving the signal may provide the user the ability to confirm and accept a transaction associated with said signal either directly or via its linked device.

Optionally, the transponder may be comprised of an input component allowing for transactions to be approved only after receiving the appropriate input from a user. An input component could be, but is not limited to, a button, a keyboard, a touch screen. One of ordinary skill in the art would appreciate that there are numerous input components that could be utilized with a transponder in accordance with embodiments of the present invention, and embodiments of the present invention are contemplated for use with any input component.

According to an embodiment of the present invention, payments made for non-toll transactions through the use of a transponder may be automatically deducted from a linked account. In this manner, the transponder account may be separate from the linked account for the purpose of paying non-toll transactions. For instance, if a user has linked their bank account with the transponder, non-toll transactions may be directly deducted from the bank account as opposed to being billed to the transponder account. For an instance, a prepaid amount may be deducted from a method of payment established with the linked account for payment of non-toll transactions and replenished when a pre-defined replenishment rule is activated

In yet another alternative embodiment, a user may select the method of payment to use to pay for a non-toll transaction. For instance, as a user may link several methods of payments to the linked account, upon using the transponder for non-toll transaction, the e-commerce system pre-defined rule may select corresponding method of payment to be used for the transaction. For instance, depending on where a transaction is made, a pre-defined rule selects corresponding method of payment to be used for the transaction. The linked method of payments may include, but not limited to: credit/debit/prepaid card, the linked account pre-payment money, direct debit from the user bank account,

By decoupling the payment account from the transponder account, for non-toll payments, the systems and methods herein described are capable of utilizing verification methods that exist beyond the control of the transponder toll payment account. For instance, if a transponder account expires or becomes suspended, the transponder may still be able to pay for non-toll transactions utilizing the transponder if the linked account is not also in the same disabled or suspended state. That is not to say that the linked accounts will always be active when the transponder account enters a different state. For instance, if a transponder is reported stolen, the linked account may be made aware of this (as described below) and in this instance, the linked account would also be disabled for use with the transponder in relation to non-toll transactions. For instance, anti fraud measures not necessarily significant for toll payment operation can be deployed by the e-commerce platform.

According to an embodiment of the present invention, a computing device linked to a transponder account may be used as a payment source at any participating and appropriately configured vendor, merchant, service provider or kiosk. The computing device may be configured to receive a signal from said appropriately configured vendor, merchant, service provider or kiosk. This signal will be provided by, for example, an appropriately configured merchant computing device, capable of interacting with the computing device of the user. The computing device of the user, upon receiving the signal may provide the user the ability to confirm and accept a transaction associated with said signal. Signals usable with a computing device include, but are not limited to, Bluetooth®, Wi-Fi, CDMA, GSM, Near Field Communications (NFC) or any combination thereof. One of ordinary skill in the art would appreciate that there are numerous signal types that could be used with embodiments of the present invention, and embodiments of the present invention are contemplated for use with any type of signal type.

According to an embodiment of the present invention, a transponder may be configured for use as an order verification system. In this manner, the transponder would be configured to communicate with a merchant to confirm the identity/account of a user. This may be useful in situations such as pharmacies, ticket booths, access control (RV/Tractor Trailer park/Gated community/hotel parking/Condos parking/laundry pickup) and other places where a user may be requested to identify themselves prior to receiving a good or service from the merchant or be granted access.

According to an embodiment of the present invention, a computing device linked to a transponder account may be configured for use as an order verification system. In this manner, the computing device linked to the transponder account would be configured to communicate with a merchant to confirm the identity/account of a user. This may be useful in situations such as pharmacies, ticket booths, access control (RV/Tractor Trailer park/Gated community/hotel parking/Condos parking/laundry pickup) and other places where a user may be requested to identify themselves prior to receiving a good or service from the merchant or be granted access.

According to an embodiment of the present invention, a transponder may be configured for providing access to VIP benefits. In this manner, the transponder may initially communicate with a merchant system. Once the merchant system has identified the transponder as belonging to someone who is to be provided VIP benefits, the benefits may be made instantly available to the user. For example, a parking lot may be equipped with a merchant system capable of interacting with the transponder. Once the merchant system confirms the transponder is associated with a user with access to VIP benefits, the merchant system may provide access to special parking areas or direct the user to spots reserved for VIPs. Other VIP benefits include, but are not limited to, drive thru check-in kiosks, hotel check-ins, VIP customer service areas, car washes and airport lounges. One of ordinary skill in the art would appreciate that there are numerous VIP benefits that may be utilized in accordance with embodiments of the present invention, and embodiments of the present invention are contemplated for use with any VIP benefit.

According to an embodiment of the present invention, a computing device linked to a transponder account may be configured for providing access to VIP benefits. In this manner, the computing device linked to a transponder account may initially communicate with a merchant system. Once the merchant system has identified the computing device linked to a transponder account as belonging to someone who is to be provided VIP benefits, the benefits may be made instantly available to the user. For example, a parking lot may be equipped with a merchant system capable of interacting with the computing device linked to a transponder account. Once the merchant system confirms the computing device linked to a transponder account is associated with a user with access to VIP benefits, the merchant system may provide access to special parking areas or direct the user to spots reserved for VIPs.

According to an embodiment of the present invention, a transponder may be configured as a form of identification triggering upon detection the display and/or submission and/or printing of coupons or advertisements available from nearby merchants or computing devices. For example, when using a transponder to pay for a transaction, the merchant POS device may print out coupons for use at a future transaction with the merchant. In another example, as a user carries their transponder by an interactive advertising kiosk (e.g., such as those contained in shopping mall entrances) and/or bulletin-boards the interactive advertising kiosk and/or bulletin-board may switch to an advertisement that most closely matches a user's interests (e.g., based on a Facebook linked account profile and/or based on age, gender or any other characteristic known to the transponder or transponder account).

According to an embodiment of the present invention, a computing device linked to a transponder account may be configured to receive or provide access to coupons or advertisements available from nearby merchants or computing devices. For example, when using a computing device linked to a transponder account to pay for a transaction, the merchant POS device may print out coupons for use at a future transaction with the merchant. In another example, as a user carries their computing device linked to a transponder account by an interactive advertising kiosk (e.g., such as those contained in shopping mall entrances) and/or bulletin-board the interactive advertising kiosk and/or bulletin-board may switch to an advertisement that most closely matches a user's interests (e.g., based on a Facebook linked account profile and/or based on age, gender or any other characteristic known to the transponder or transponder account).

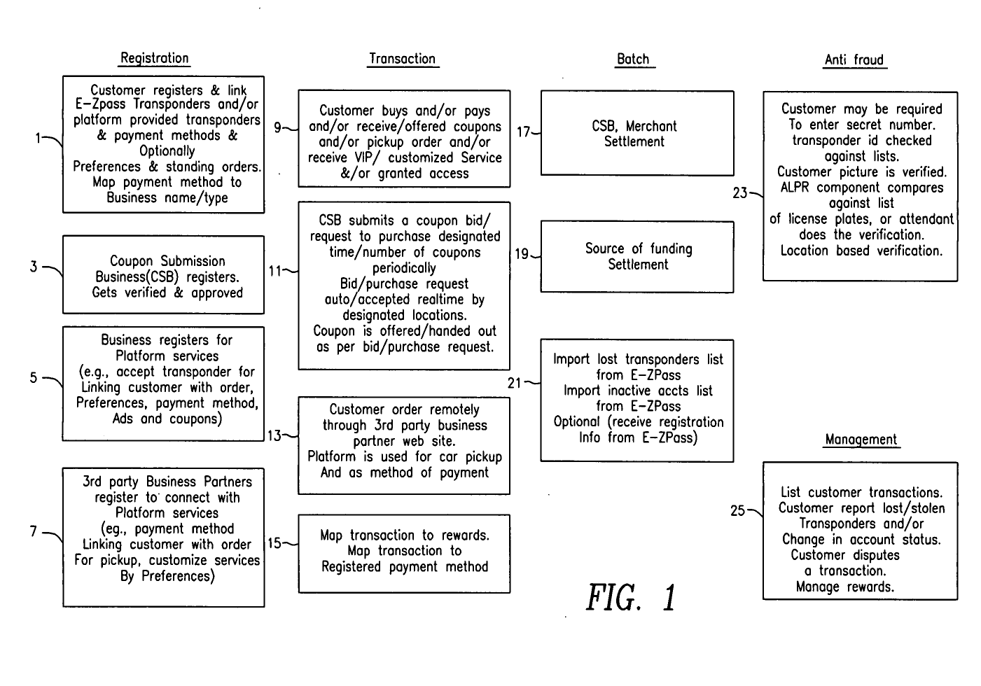

Turning now to FIG. 1, a schematic overview in accordance with an embodiment of the present invention is shown.

### Registration

As described, since the E-ZPass system is not designed for commerce, the customer has to, 1, link his E-ZPass tag and other information as required to the eCommerce system. The linking may occur automatically. Customer consent is required. Some of the eCommerce transaction types (e.g. rewards and offers) are based on detection and do not require any additional information. Communication with customers will be accomplished through the cashier and/or a visible display. No payment method is utilized.

Coupon providers, 3, have to register with the eCommerce system to make their coupons available to eCommerce customers. A business who would like to utilize the eCommerce platform to speed up and personalize shopping experience and other car based (e.g. parking, car wash) shopping channels have to register with the eCommerce system, 5. Third party businesses partners have to register 7 with eCommerce to offer advertisement, remote ordering, rewards, auto check-in related program and/or other services to eCommerce customers.

### Transaction

After a customer registers with the eCommerce system, at locations where the eCommerce is accepted, the customer presence is detected based on his method of detection (e.g. E-ZPass tag) 9. Customer default order, preferences, personalized coupon, advertisement, access rights, linked payment method and other information can all be used to offer a quicker, personalized and expanded service, 11. Coupon providers can bid/purchase a time slot or number of times when their coupons will be made available to relevant customers at the order of their bidding price 13, customer may use third party business partner software to remotely order or reserve service/products and link the reservation to their eCommerce account. Upon arrival at the merchant, the eCommerce system will link their presence to their pending order for quicker, personalized and expanded pickup service, 15. Upon detection of presence or consuming a transaction eCommerce will credit customer account with linked third party business rewards. In addition eCommerce will use customer preferences to link customer choice of payment method/reward card to consumed transaction

### Batch

Other post transaction system activities will occur asynchronously after transactions are completed, including 17, settlement with/reporting to coupon/advertisement/reward/check-in program providers and 19, settlement with the financial institution or business providing the funding for the transaction.

In addition, 21, every so often information will be exchanged between the closed system (e.g. E-ZPass system), and eCommerce system to report stolen/lost method of detection (e.g.-ZPass tags), delinquent account, closed account, closed system (e.g. E-ZPass) customer registration information, eCommerce transactions for settlements as if eCommerce joins the closed system (e.g. E-ZPass system), and becomes a closed system (e.g. an E-ZPass) approved agency for eCommerce customers toll payment purposes.

### Anti Fraud

As with any other payment card providers, 23, different methods will be used to prevent fraud, including requesting additional customer information for system verification or showing additional customer information for merchant attendant verification or other automatic means of monitoring account for any exceptions to customer shopping behavior

### Management

As shown at 25, all stakeholders (e.g., customers, merchant, coupon providers, reward providers, check-in program providers, advertisement providers, access control providers) will be able to view their information and manage their eCommerce accounts on-line. The same access, only read-only and filtered will be available to customer service representatives.

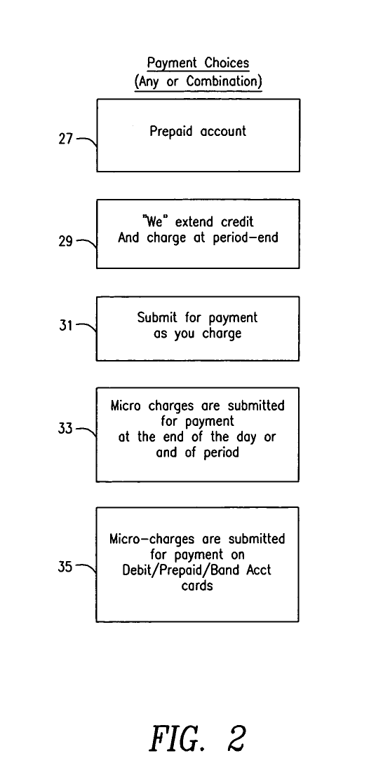

Turning now to FIG. 2, a diagram of a certain exemplary payment choices in accordance with an embodiment of the present invention is shown.

### Payment Method Choices

As shown at 27, a customer is allowed to link another pre-paid account to his existing method of detection device (e.g. E-ZPass tag), creating a dual purse; one used by the closed system (e.g. E-ZPass) for example, to pay for customer tolls and major airport parking where E-ZPass is accepted and the other used by eCommerce to pay for all other customer purchases at eCommerce managed toll plazas and for non-toll purchases at location where drive-thru is accepted upon eCommerce managed devices (e.g.-ZPass) readers detecting a device (e.g. an E-ZPass tag)

As shown at 29, a customer is also allowed to use his E-ZPass tag as a credit card where eCommerce extends credit to customers for purchases made through their eCommerce-account-linked detection device (e.g. E-ZPass tag).

As shown at 31, a customer is also allowed to create an account with eCommerce in addition to their closed system (e.g. E-ZPass) account. In their eCommerce account customer can link method of payment(s) to their method of identification (e.g. E-ZPass tag). Wherever eCommerce is accepted; customers using their method of detection (e.g. E-ZPass tag) can make purchases through their eCommerce account, charging their linked method of payment(s)

As shown at 33, a customer is allowed to create an account with eCommerce in addition to their closed system (e.g. E-ZPass) account. In their eCommerce account customer can link method of payment(s) to their method of detection (e.g. E-ZPass tag). Wherever eCommerce is accepted; customers using their method of detection (e.g. E-ZPass tag) can make small amount purchases through their eCommerce account. At the end of the day or pre-determined period of time the aggregation of their purchases will be charged to their linked method of payment(s). Numeral 35 presents the option where small amount payments are charged immediately to customer-linked methods of payment(s)

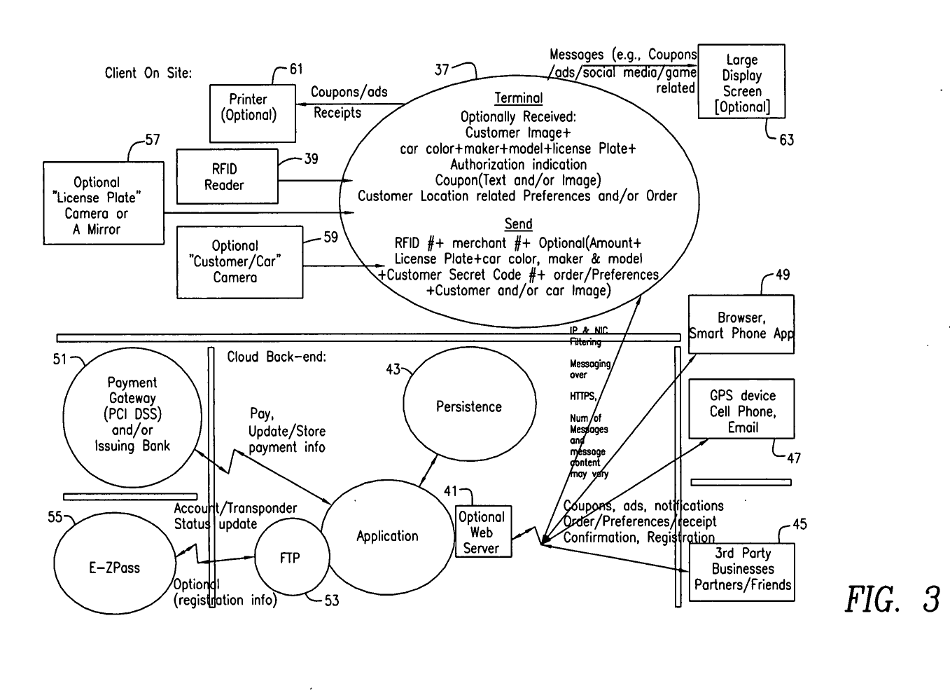

With reference to FIG. 3:

### Architecture—Overview

As the core idea is to leverage the huge investment in closed system devices (e.g. E-ZPass RFID tags with over 22 million tags in circulation), assuming manufacturing, processing and distribution cost ranges are from $8.90 to $25. As in NH it cost $8.90 to $15 http://www.nh.gov/dot/org/operations/turnpikes/ezpass/index.htm: and in NY: Tag deposit is $10 and replacement cost between $25 to $33: https://www.e-zpassny.com/en/about/terms_ind.shtml. Using $10 as a benchmark, the investment in E-ZPass tags exceeds $220 million). The present invention unlocks this potential (e.g. leveraging the E-ZPass tag investment for non-toll usages beyond its current toll and limited parking usages and into commerce and even beyond payment-only usages) by creating a dual purse linked to the method of detection (e.g. E-ZPass tag) while optionally maintaining loose coupling with closed system (e.g. the E-ZPass) server processing infrastructure. To support the dual purse (i.e., each customer has two accounts: one maintained by the closed system (e.g. E-ZPass), the other maintained by eCommerce while both accounts are linked to the device (e.g. E-ZPass tag) the invention provides architecture designed to detect the consumer's device (e.g. an RFID tag) and process a generated transaction where a transaction can be:
A payment transaction,
An automatic reward transaction via an automatic check-in at the account level and/or with a 3^{rd} party system (e.g., Facebook®, FourSquare®, as part of a game)
Receiving an advertisement/coupon via a linked mobile device (e.g., cell-phone) or linked application (e.g., smart phone application) or linked account (e.g., email, SMS) or via billboard or via a large display or via a GPS system
Showing customer preferences, default, previous, or currently placed order

### Architecture

As a consumer method of detection (e.g. an E-ZPass RFID tag) is detected by the reader (e.g. RFID reader) 39, information related to the linked eCommerce account is communicated to the local terminal, 37. The flow may go from:
The reader sending the identification signal id (e.g. E-ZPass transponder tag ID) directly to the central server (e.g., Cloud based server) application 41 and from the application sending linked account information to the local, on site terminal 37 which may be realized as: credit card terminal, point of sale (POS), register, eCommerce terminal, or other third party terminals;
Or, may go from the reader 39 sending the identification signal id (e.g. E-ZPass transponder tag ID) to the terminal 37 and from the terminal sending a request to get linked account information to the application server 41 returning tag-id linked account information.

Once the terminal receives the customer linked account information it may show any combination of the following:
Customer information (e.g., name, picture, car license plate number, car type/color)
Customer order and/or selected previous order(s)
Preferences
Personalized offers/coupon/advertisement/notifications/other messages (e.g., social media messages, third party messages).

The information may be shown on local screen and/or a detached screen 63, a printer 61, and/or on a customer mobile device, 49, 47.

The information may also be communicated to a third party business partner 45 for up-to-the-minute communication between the third party business partner and the customer (e.g., last minute offers, notifications, rewards, check-in, game scenario) either directly or through Drive thru architecture components.

Another option is that once the terminal receives the customer linked account information either the attendant or the customer will be requested to enter customer personal identification which will be sent to server for further identification or to confirm identification or selection of the communication to be received back (e.g., a customer may have a standing option triggered via the key code, or can be part of a game or can be part of identifying the customer when more than 1 customer profile are linked to the same RFID tag.

Or, additional customer identification can be collected via a camera 59 or a license plate camera and digitizing system (e.g., Automatic License Plate Recognition System (ALPR) system) or a mirror 57 positioned in a way to show customer's car/vehicle license plate.

Another option is that the customer will receive communication on his mobile device, 47, 49, as soon as his device (e.g. RFID tag) is detected for further id confirmation and/or additional messages and/or additional dialog and/or confirmations, also possibly directly or indirectly from third party business partners and/or friends.

Another option is for the back-end application 41 to communicate directly with customer mobile device 47, 49 upon detection by the reader and/or to facilitate communication with third party business partners and/or friends 45.

The back-end application 41 has a persistence module 43 to store transaction information and/or store event information and/or retrieve information linked to customer account.

In addition the back-end application 41 may run on a web server shown in 41 to facilitate communication with the outside.

In addition, the back-end application 41 will use a payment gateway 51 to process payment.

If E-ZPass is the closed system, as currently all communication among and with E-ZPass agencies is done via a File Transfer Protocol (FTP) 53, the back-end application will use FTP to process payment from/to other E-ZPass agencies 55 in the event eCommerce decides to process payment through the closed system (e.g. when processing toll payment or airport parking payment), and/or receive a file from a closed system (e.g. E-ZPass agency) for payment in the event where eCommerce processes payment for other closed systems (e.g. other E-ZPass agencies) eCommerce becomes an E-ZPass agency and when a eCommerce customer goes through a E-ZPass toll plaza, the owner agency will send request for payment from eCommerce and/or receive a file from another E-ZPass agency for payment processing as per that agency payment requirement.

Also, communication with closed system (e.g. E-ZPass) 55 over FTP 53 may include receiving/reporting lost/stolen tags delinquent/closed accounts.

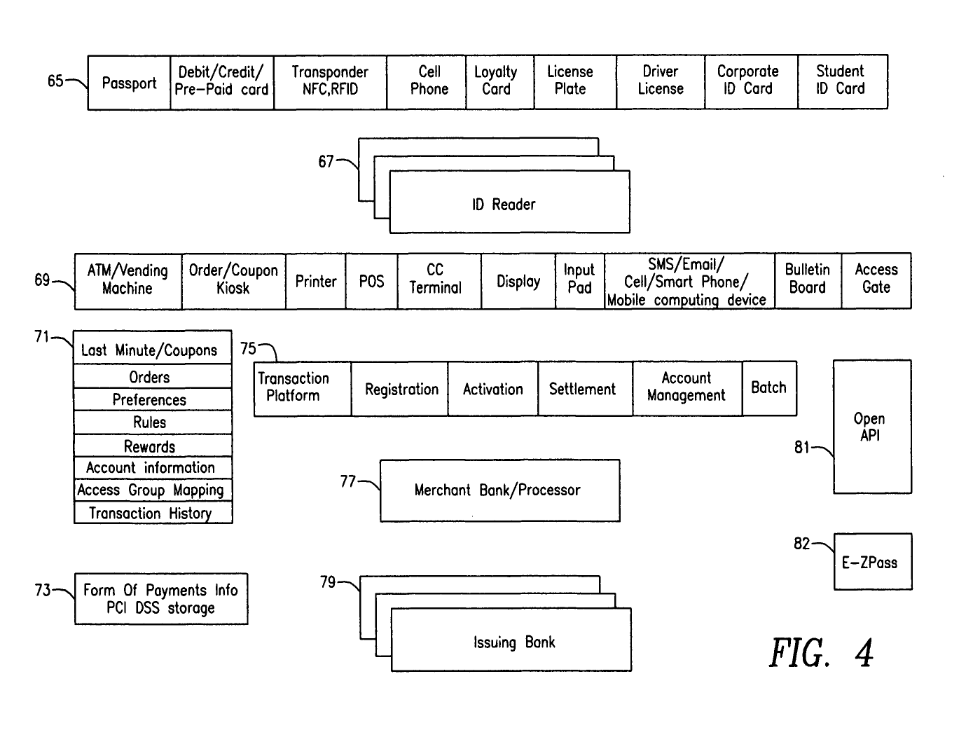

Turning now to FIG. 4, a high level system diagram in accordance with an embodiment of the present invention is shown. FIG. 4 depicts:
1. At 65, a transponder account that may be extended beyond transponder (meaning: not only a transponder as a method of identification and not only a single method of payment) with multiple method of identifications and payments linked to the same account;
2. An e-commerce platform may install various ID readers 67 and/or method of payment transaction processing machines, 69, at POS, at its own Kiosk (may be located at a parking lot of a mall), ATM/vending machine, access gates shown in 69;
3. One or more methods of payment 65 can also be used as a method of identification and vice versa;
4. The e-commerce platform may support various communication channels with its customers including but not limited to, large/small Monitor, pad, personal devices (e.g. iPad®, cell phone, smart phone), sms, email, as shown at 69;
5. The e-commerce platform may support an open API, 81, to allow third party providers to utilize customer preferences and method of payments and method of identifications;
6. As shown at 71, for example, last minute coupons may be submitted by businesses to neighboring/designated businesses, so when a customer arrives and detected by the e-commerce platform the submitted coupon can be offered to the customer either electronically or physically printed out. The coupon may be an ad-hoc one offering perishable items and/or excess capacity and only be offered for a limited time or until removed; and
7. The e-commerce platform interface with the issuing bank, 79, will allow sharing of the same funds among various methods of payments.
   Form of payments information may be stored, for instance, in PCI DSS certified storage either directly on the e-commerce platform or at a 3^{rd} party gateway.
   Interfacing with E-ZPass or Other Closed System, 82.

Some exemplary methods for interfacing with E-ZPass or other closed systems include, but are not limited to:
1. E-ZPass and/or other closed system may be configured to allow non-toll services to be marketed to their customers;
2. E-ZPass and/or other closed system customers may be provided a method to register with the eCommerce platform and/or direct and authorize E-Zpass and/or other closed system to provide their record or part of their record to the eCommerce platform;
3. E-ZPass Group and/or other closed system may be configured to provide lost/stolen tags feed periodically (e.g., on an hourly basis);
4. E-ZPass Group and/or other closed system may be configured to provide device (e.g. tag) status feed periodically (e.g., daily) showing which customers' devices (e.g. tags) are no longer eligible to participate in their corresponding toll paying service;
5. E-ZPass Group and/or other closed system may license the use of their Service Mark;
6. E-ZPass Group and/or other closed system may grant permission to purchase readers;
7. One or more non-closed business (e.g. non-toll) platform providers may install/maintain equipment in a non-closed (e.g. non-toll) business either directly or through a third party provider
8. Non-closed customer/business (e.g. toll customer business) support/service may be handled by the non-closed system (e.g. non-toll) platform provider either directly or through a third party provider; and
9. A provision may be made in a platform to exclude products/services not authorized by the closed system (e.g. E-ZPass group) such as alcoholic beverages or gambling.

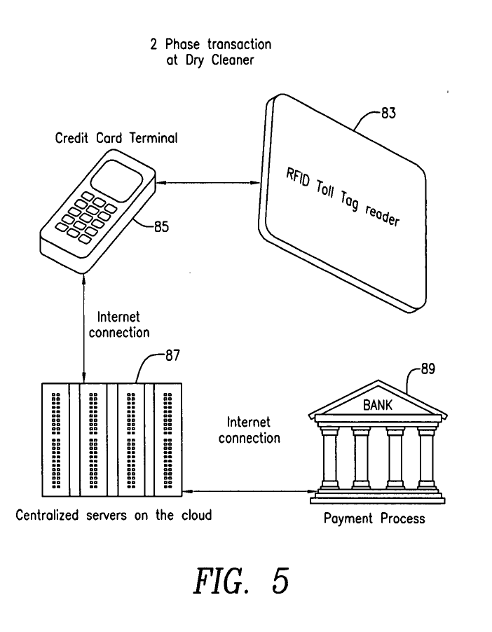

FIG. 5 is a diagram of an installation of the present invention at a dry cleaning establishment. A two phase transaction is supported for payment and express registration transactions where the first phase is the same in both transaction types. The steps of phase 1 are:
1. The E-ZPass RFID tag in approaching car is detected by the RFID reader 83;
2. The RFID reader 83 sends the E-ZPass RFID tag ID to a credit card terminal 85 in the store;
3, Credit card terminal 85 sends the E-ZPass RFID tag ID to a centralized server 87 on the Amazon® cloud;
4. If the E-ZPass RFID tag is registered with the drive thru service, the server 87 responds with customer name and preferences which the credit card terminal 85 shows on a screen. If not registered, server 87 responds that tag is not registered and the credit card terminal 85 offers the cashier the option to express register the customer's E-ZPass RFID tag id with the drive thru service (e.g., eCommerce). If tag is registered, credit card terminal offers 85 the cashier the option to pay using the customer tag ID's linked credit card.

The steps of phase 2, payment flow, are:
1. If the cashier press the pay button or express register button on the credit card terminal 85, phase 2—payment flow, of the transaction begins;
2. For a pay transaction credit card terminal 85 requests the cashier to enter the transaction amount, customer last 4 digits of account registered cell-phone and press the submit button. When submit button is pressed, credit card terminal 85 triggers reader 83 to read toll tag ID and when it receives the toll tag ID again it verifies that it is the same as the original one. If it is the same as the original one and entered last 4 digits of cell-phone are valid, credit card terminal submits the transaction for authorization to the centralized server 87 which matches the tag id with account method of payment. chooses the method of payment to charge and sends it with the amount to the merchant designated payment processor 89;
3. The approved/decline response received from the payment processor 89 is stored and communicated back to the credit card terminal 85;
4. All transaction information is recorded on the server side.

The express registration steps are:
1. If cashier presses the express registration button then the terminal 85 requests the cashier to:
   Swipe a credit card to be linked as a payment of method to the tag ID;
   Enter customer cell-phone number, customer last 4 digits of toll tag ID and optionally transaction amount; and
   Click the submit button.
2. Terminal 85 validates last 4 digits of tag ID against the tag ID read and submits the information to the centralized server 87;
3. The centralized server 87 records transaction information and submits for payment; authorization if amount is greater than zero to merchant designated payment processor 89;
4. A decline or approved response is communicated back to the credit card terminal 85 with an express registration key which the customer may use to express register on the drive thru (i.e., eCommerce) web site. The customer can also use the credit card number used at the time of express registration and cell phone's last 4 digits to express register on the drive thru (i.e., eCommerce) web site.

Instead of E-Z Pass as a closed system, a cell-phone carrier closed system where all aspects of the invention remain the same, links a payment account to the CDMA/GSM signal device ID.

While multiple embodiments are disclosed, still other embodiments of the present invention will become apparent to those skilled in the art from this detailed description. The invention is capable of myriad modifications in various aspects, all without departing from the spirit and scope of the present invention. Accordingly, the drawings and descriptions are to be regarded as illustrative in nature and not restrictive.

I claim:

1. A method for extending toll transponders and toll transponder accounts by automatically deducting non-toll transactions from a linked account comprising the steps of
a. linking a payment account with the toll transponder, and b. deducting non-toll transactions from said account.

2. The method of claim 1 further including the step of periodically replenishing said account.

3. A method for extending toll transponders and toll transponder accounts by automatically deducting non-toll transactions from a plurality of linked accounts comprising the steps of:
a. linking a plurality of payment accounts with the toll transponder; b. selecting one of said payment accounts for a non-toll transaction; and c. deducting non-toll transactions from said account.

4. The method of claim 3 wherein said payment account is selected automatically.

5. A method of decoupling the toll payment account from a toll transponder account to enable the use of toll transponders for non-toll uses comprising the steps of: linking at least one non-toll use to a toll transponder; and disabling said linked use if said toll transponder is reported stolen.

6. The method of claim 1 further including the steps of automatically fulfilling said non-toll transaction by selecting and displaying stored customer previously purchased/or preferred orders.

7. The method of claim 1 further including the step crediting a customer account with rewards.

8. The method of claim 1 further including the step of automatically checking in.

9. The method of claim 1 further including the step of automatically presenting a customer with coupons.

10. The method of claim 1 further including the step of automatically presenting a customer with advertisements.

11. The method of claim 1 further including the step of automatic pick up of desired orders by delivery to the customer's vehicle.

12. A method of extending the use of electronic devices which generate an identification signal comprising the steps of detecting said identification signal; linking at least two payment accounts to recognize said identification signal; and automatically debiting one of said payment accounts.

13. The method of claim 12 wherein said electronic device is an RFID transponder.

14. The method of claim 12 wherein said electronic device is Bluetooth®, Wi-Fi, CDMA, GSM, Near Field Communications (NFC) or any combination thereof.

15. A method of extending the use of proprietary systems utilizing electronic devices which generate an identification signal comprising the steps of linking forms of payment, preferences and general information to the identification signal by customer registration; and utilizing said customer registration upon detection of said identification signal.

16. The method of claim 15 wherein said electronic device is an RFID transponder.

17. The method of claim 15 wherein said electronic device is Bluetooth®, Wi-Fi, CDMA, GSM, Near Field Communications (NFC) or any combination thereof.

18. The method of claim 15 wherein said customer registration is utilized to automatically debit one of said forms of payment.

19. The method of claim 15 wherein said customer registration is utilized to automatically provide rewards.

20. The method of claim 15 wherein said customer registration is utilized to provide automatic check-in.

21. The method of claim 15 wherein said customer registration is utilized to provide automatic receipt of advertisements.

22. The method of claim 15 wherein said customer registration is utilized to provide automatic receipt of coupons.

23. The method of claim 15 wherein said customer registration is utilized to provide order verification.

24. The method of claim 15 wherein said customer registration is utilized to provide customer preferences, customer defaults, or customer order history.

25. A method of extending the use of proprietary systems utilizing electronic devices which generate an identification signal comprising the steps of: automatically, without registration, utilizing said identification signal to provide a customer with the options of selection of previous customer orders at the point of ordering; and/or offering customer up-sale options and/or other offers and/or rewards and/or advertisements based on past purchases and/or past utilizations of said identification signal.

26. A method of extending the use of proprietary systems utilizing electronic devices which generate an identification signal comprising the steps of: linking a computing device and/or cell phone to said computing device and generating information corresponding to said identification signal.

27. The method of claim 26 wherein said information is offers from merchants.
